(19) United States
(12) Patent Application Publication
(10) Pub. No.: US 2012/0096380 A1
(43) Pub. Date: Apr. 19, 2012

(54) Color Selection Graphical User Interface

(76) Inventor: David L. Wagner, Broomfield, CO (US)

(21) Appl. No.: 12/903,284

(22) Filed: Oct. 13, 2010

(51) Int. Cl. G06F 3/048

(52) U.S. Cl. 715/771; 358/1.9

(57) ABSTRACT

A graphical user interface (GUI) disclosed. The GUI includes a color palette to enable color selection by providing an independent mix of each color component in a color space.

### FIELD OF THE INVENTION

The invention relates to the field of graphics applications. Particularly, the invention relates to selecting colors in a graphics application.

### BACKGROUND

Computer software programs such as page layout programs, graphical illustration programs and image processing programs provide users with the ability to create, edit and display electronic documents that include color. Typically, such programs also provide users with the ability to print a document. Moreover, many programs attempt to represent documents on a display device in colors that bear some relation to the colors that will be output by a printer.

Conventional graphics illustration programs, such as photo-editing software, enable the selection of colors for drawing. However display devices are two-dimensional, while interesting color spaces have three components (RGB, Lab, HSV) or four components (CMYK). Thus, a program graphical user interface (GUI) typically displays a plot of two of the color components against each other as the remaining color components are fixed. Having to fix one or more colors during color selection provides for a cumbersome user experience.

Therefore, an interface to display each color component during color selection is desired.

### SUMMARY

In one embodiment a graphical user interface (GUI) disclosed. The GUI includes a color palette to enable color selection by providing an independent mix of each color component in a color space.

In another embodiment, a computer generated method is disclosed. The method includes receiving a color selection via a GUI, generating a mixed color corresponding to the color selection, drawing a plot around the mixed color within a color palette in the GUI and drawing arrows from the plot representing each component of a color space used to generate the mixed color.

In yet a further embodiment a computer system is disclosed, including a memory to store a printing software product, a processor, coupled to the memory, to execute the printing software product and a display device to display a graphical user interface (GUI) upon the processor executing the printing software product. The GUI includes a color palette to enable color selection by providing an independent mix of each color component in a color space.

### BRIEF DESCRIPTION OF THE DRAWINGS

A better understanding of the present invention can be obtained from the following detailed description in conjunction with the following drawings, in which:

FIG. 1 illustrates one embodiment of a data processing system network;

FIG. 2 is a screen shot of a conventional color selection GUI;

FIG. 3 is a flow diagram illustrating one embodiment of performing color selection;

FIGS. 4A-4C illustrate screen shots of one embodiment of a color selection GUI;

FIGS. 5A and 5B illustrate screen shots of one embodiment of color patch selection;

FIG. 6 illustrates one embodiment of a computer system.

### DETAILED DESCRIPTION

A color selection GUI is described. In the following description, for the purposes of explanation, numerous specific details are set forth in order to provide a thorough understanding of the present invention. It will be apparent, however, to one skilled in the art that the present invention may be practiced without some of these specific details. In other instances, well-known structures and devices are shown in block diagram form to avoid obscuring the underlying principles of the present invention.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

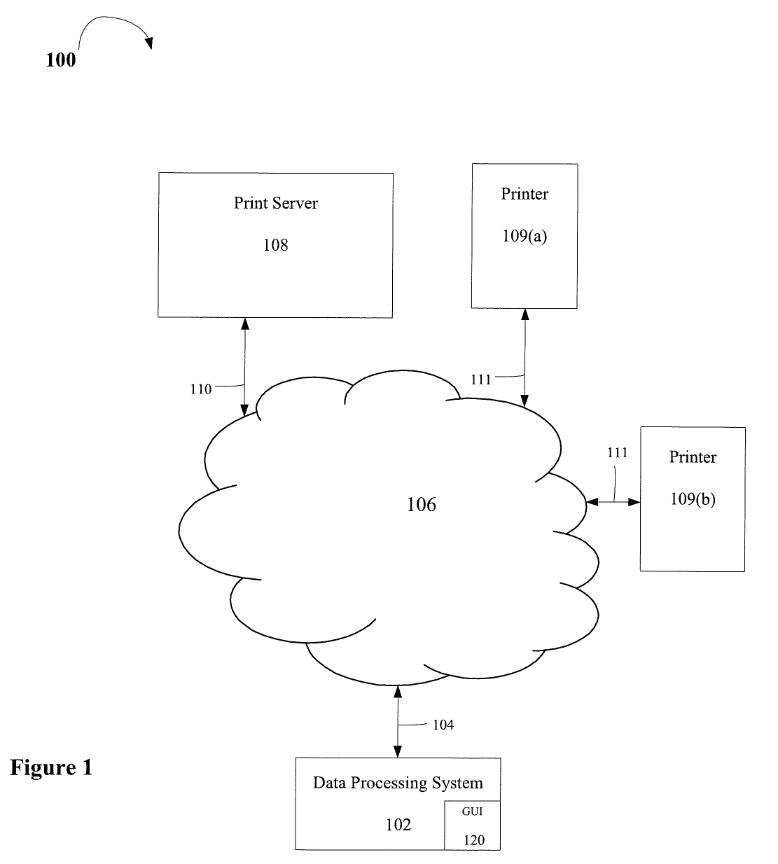

FIG. 1 illustrates one embodiment of a data processing system network 100. Network 100 includes a data processing system 102, which may be either a desktop or a mobile data processing system, coupled via communications link 104 to network 106. In one embodiment, data processing system 102 is a conventional data processing system including a processor, local memory, nonvolatile storage, and input/output devices such as a keyboard, mouse, trackball, and the like, all in accordance with the known art. In one embodiment, data processing system 102 includes and employs the Windows operating system, or other operating system, and/or network drivers permitting data processing system 102 to communicate with network 106 for the purposes of employing resources within network 106.

Network 106 may be a local area network (LAN) or any other network over which print requests may be submitted to a remote printer or print server. Communications link 104 may be in the form of a network adapter, docking station, or the like, and supports communications between data processing system 102 and network 106 employing a network communications protocol such as Ethernet, the AS/400 Network, or the like.

According to one embodiment, network 106 includes a print server 108 that serves print requests over network 106 received via communications link 110 between print server 108 and network 106. Print server 108 subsequently transmits the print requests via communications link 110 to one of printers 109 for printing, which are coupled to network 106 via communications links 111.

Although described as separate entities, other embodiments may include print server 108 being incorporated in one or more of the printers 109. In yet further embodiments, the print server and printer may be physically separate entities. Therefore, the data processing system network depicted in FIG. 1 is selected for the purposes of explaining and illustrating the present invention and is not intended to imply architectural limitations. Those skilled in the art will recognize that various additional components may be utilized in conjunction with the present invention.

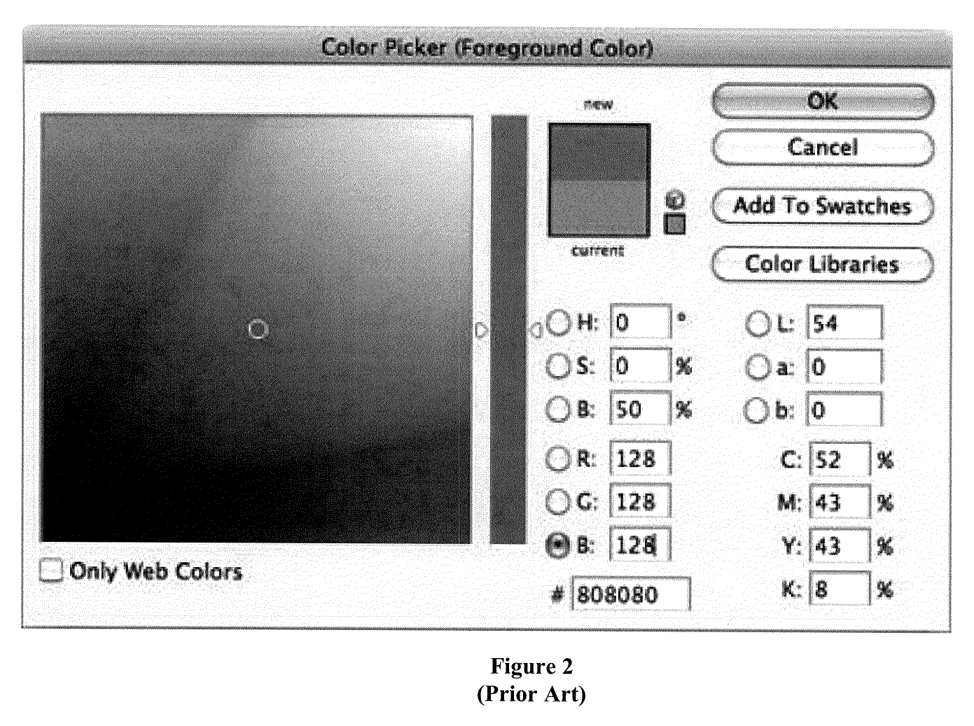

According to one embodiment data processing system 102 implements a computer software product to enables color selection in documents on a display device in colors that may be printed at one or more of printers 109. Data processing system 102 includes a GUI 120 that facilitates the color selection. As discussed above, conventional programs implement display a plot of two of the color components against each other while holding the remaining color components fixed. For example, FIG. 2 is a screen shot of a conventional color picker GUI that displays two color components (e.g., red versus green) while holding the third color component (blue) constant. Moreover, conventional programs do not have an option for displaying components of CMYK versus one another.

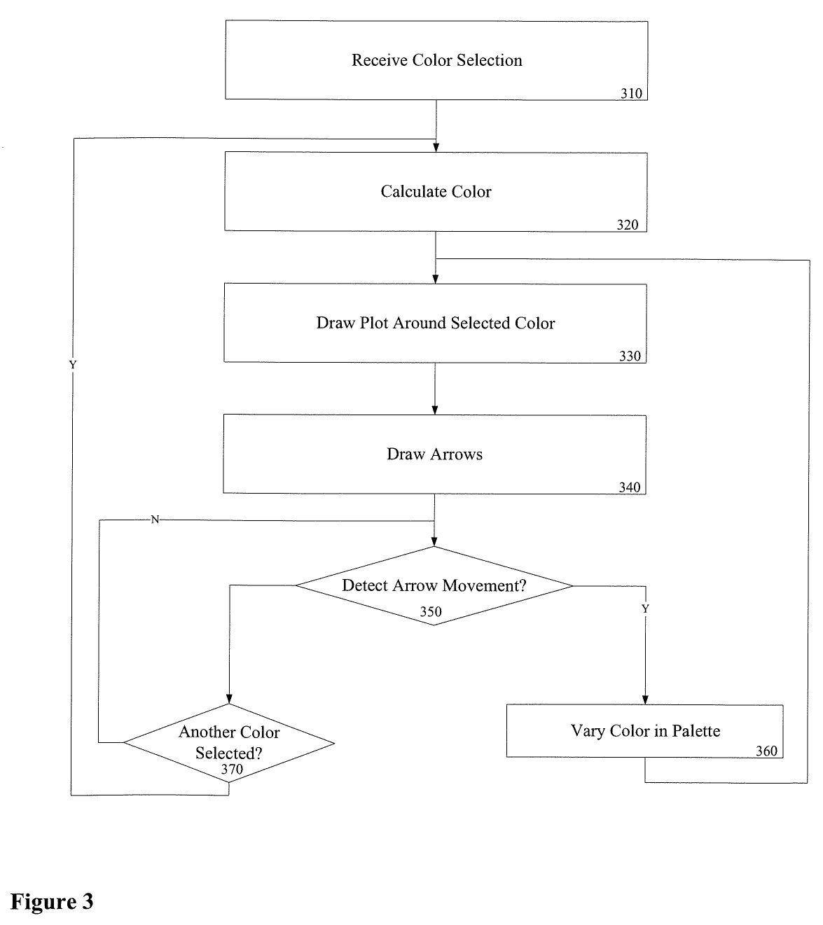

According to one embodiment, a GUI 120 enables color selection by providing an independent mix of each color component in a color space. Thus a user of GUI 120 may interactively adjust the mix of displayed colors without having to fix one of the color components. FIG. 3 is a flow diagram illustrating one embodiment of performing color selection performed using a computer software product operating at data processing system 102.

At processing block 310, an initial color selection is received upon a user interacting with GUI 120. In one embodiment, the selection is made by the user activating a cursor control device (e.g., a mouse). For example, the user may use the mouse to double click on a spot within a color palette window. Alternatively, a user may simply enter color component values into GUI 120 to select a color. At processing block 320, the computer software product calculates a mixed color corresponding to the selected (or entered) values. At processing block 330, a plot is drawn around the calculated mixed color, where the mixed color is the color in the center of the plot.

At processing block 340, arrows representing each component of a color space are drawn starting from the center of the plot. For instance four arrows are drawn for CMYK and three arrows for are drawn for RGB or Lab, etc. In one embodiment, the direction of each arrow indicates a direction for which the particular component changes, while the arrow's length indicates how rapidly that component changes.

In a further embodiment, a user may rearrange the arrows to vary the direction and amount of change of each component by dragging the arrows around. Therefore at processing block 350, a determination is made as to whether arrow movement is detected. If movement of any of the color component arrows is detected, the colors presented in the palette are changed accordingly, processing block 360. Subsequently, control is returned to processing block 330 where a plot is drawn around the newly selected mixed color.

If no arrow movement is detected, it is determined whether another color selection has been made, decision block 370. If so, control is returned to processing block 320 where a new mixed color is calculated. Otherwise, control is returned to processing block 350 where it is determined whether further arrow movement is detected.

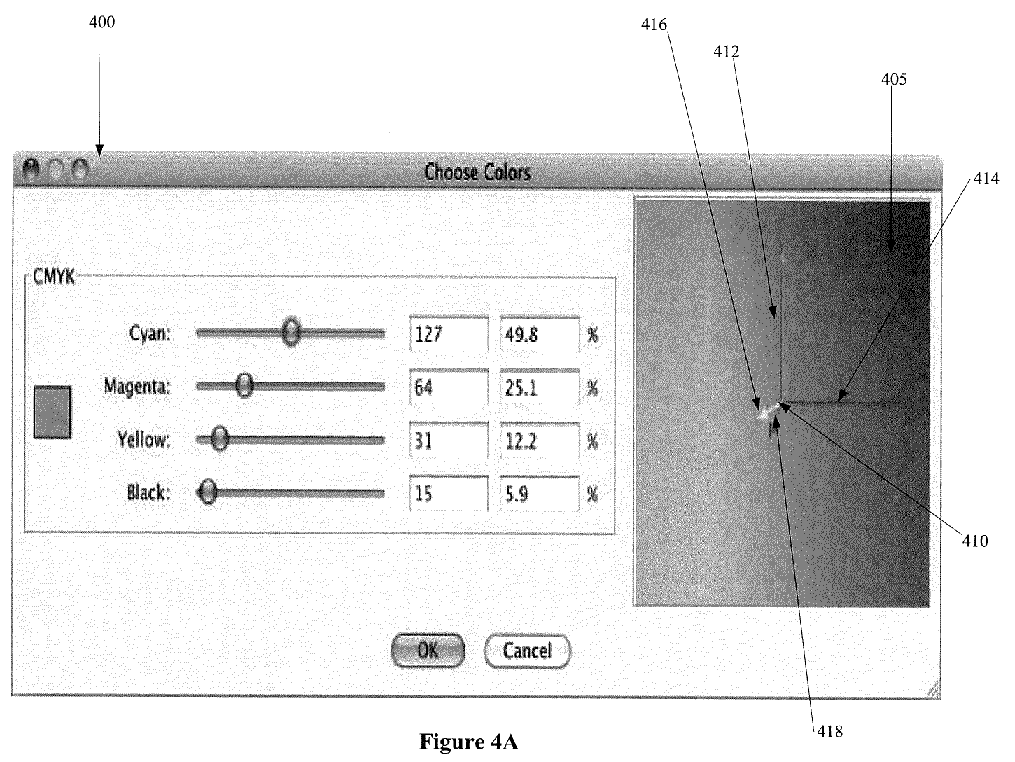

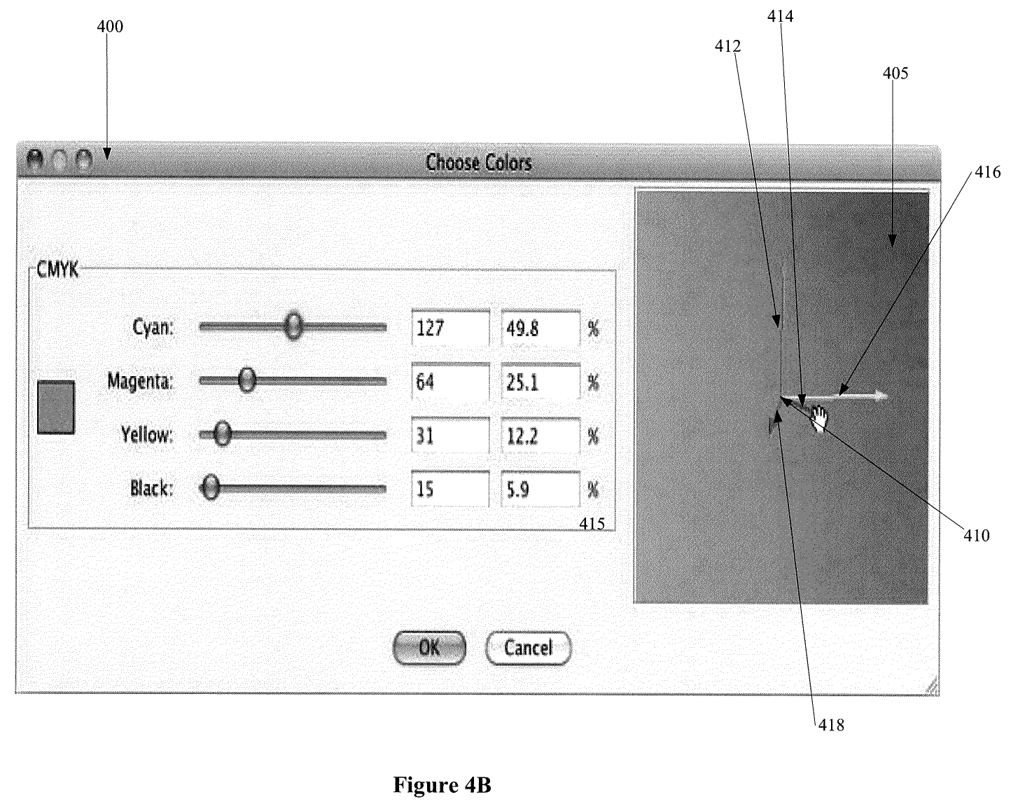

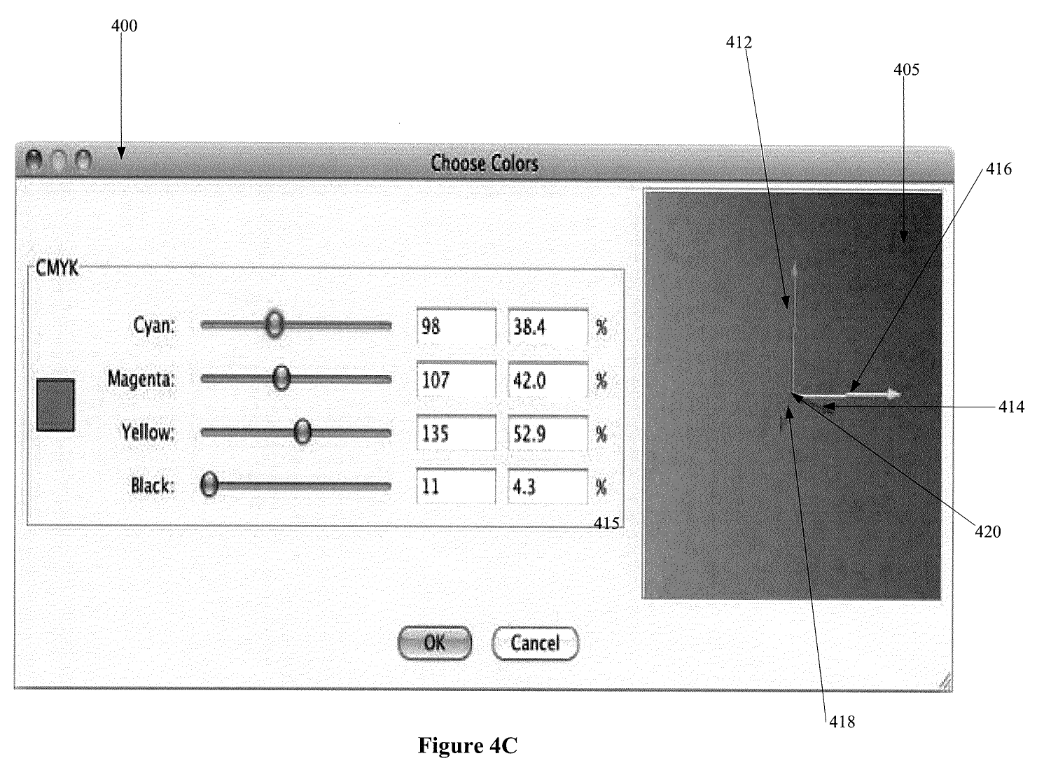

FIGS. 4A and 4B illustrate screen shots of one embodiment of a color selection GUI 400 implemented using the process described above in FIG. 3. FIG. 4A shows an embodiment of GUI 400 providing for color selection using CMYK. GUI 400 includes color component selection boxes that enable a user to enter and/or edit color component values. As shown in FIG. 4A, a currently selected CMYK color has component values C=127, M=64, Y=31, B=15.

GUI 400 also includes a color palette 405 having the currently selected color drawn in a center pixel of a color plot 410 with arrows 412, 414, 416 and 418, representing cyan, magenta, yellow and black, respectively, drawn from plot 410. As discussed above, the color components are determined by the lengths of the arrows. Thus, the color increase of a component is proportional to the length of its respective arrow.

FIG. 4A shows colors in which cyan components 412 change vertically and magenta components 414 change horizontally. For instance, the cyan component 412 changes rapidly going upwards on the plot and decreases rapidly going downwards. Similarly, the magenta component 414 increases rapidly to the right and decreases rapidly to the left. Since the yellow arrow 416 and black arrow 418 are small, these components increase slowly to the left and downwards.

According to one embodiment, the arrow for each component is considered as a vector. For example, the cyan vector might be C=(CX, CY). Considering a vector P=(x, y) that locates any point on the plot (where (0,0) is the center of the plot and the plot of colors ranges from −127 to +127 in X and −127 to +127 in Y), the change in the cyan component is the dot product of the two vectors: ΔC=C*P=CX*x+CY*y. Thus, adding in the starting value at (0,0) results in a value of cyan at the point (x,y). This process is subsequently repeated for all other color space components independently for all points in the plot. Since the valid range of each of C, M, Y and K is 0 to 255 the value is set to 0 if the calculation results in a value below 0. Similarly, the value is set to 255 if the calculation results in a number larger than 255.

In FIG. 4A, the cyan arrow 412 may be represented by C=(0.0, 1.0). That is, the arrow 412 points only upwards in the Y direction. As an example, the cyan arrow 412 becomes C=(0.2, 1.0) if the user drags the arrow slightly to the right. As a result, the plot is re-calculated with new colors. Considering any arbitrary point (e.g., P=(15, 10)), which is 15 pixels right of the center point, and 10 pixels upwards from the center point, the value of the cyan component at that particular pixel is C=127+0.2*15+1.0*10=140. The magenta arrow is still pointing M=(1.0, 0.0), so the new magenta component at the same point is M=63+1.0*15+0.0*10=78. This process is performed for all of the points in the plot for each of the four color components, thus providing the color value for every pixel in the plot.

Using the mouse, the arrows may be reduced or stretched in any direction. FIG. 4B shows an embodiment of GUI 400 after dragging the yellow arrow 416 and magenta arrow 414 so that the plot primarily shows cyan versus yellow. As shown in FIG. 4B, the selected color (e.g., center of plot) does not change when dragging the arrows. In one embodiment, a new center color can be selected by double-clicking the mouse on a color somewhere on palette 405. Such a selection results in GUI 400 displaying a new plot around the newly selected color.

FIG. 4C shows GUI 400 after a new color has been selected. As shown in FIG. 4C, a new center of plot 420 is drawn representing having component values C=98, M=107, Y=135, B=11, and are automatically updated within the color component selection boxes. This process may be repeated until the desired color is found. Once color selection is completed the user may select the OK button.

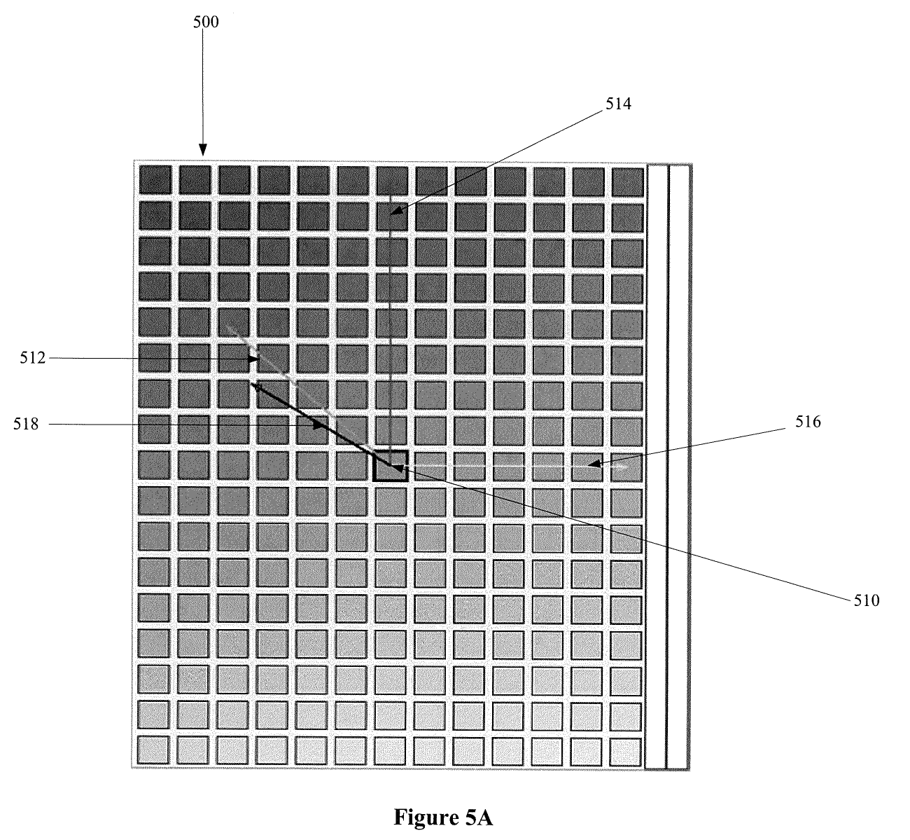

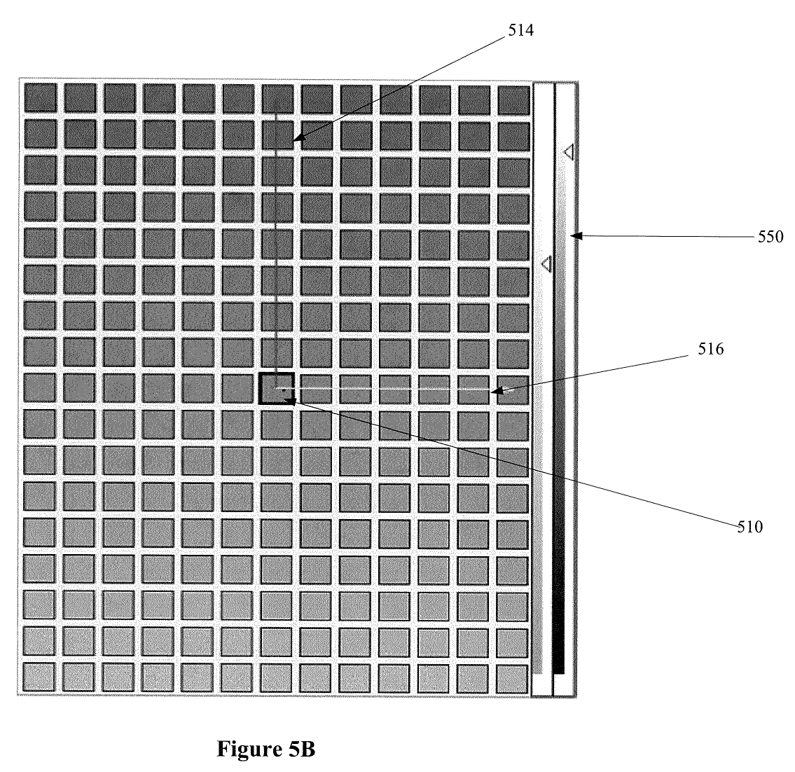

In another embodiment, the color selection computer software product may be included in a printing software product to enable the selection of color patches to be printed at a printer 109. Traditionally, color patches are printed on numerous pages where the patches are arranged as cyan versus magenta, or magenta versus yellow. The present color selection mechanism enables color patches that may vary. FIG. 5A illustrates one embodiment of a patch selection mechanism implementing color selection, and including a color plot 510 with arrows 512, 514, 516 and 518, representing cyan, magenta, yellow and black, respectively, drawn from plot 510.

In one embodiment, the value of the corresponding color component is the same for every patch if one or two of the arrows are reduced to zero length. FIG. 5B illustrates one embodiment of such a scenario where the cyan component 412 and the black component 518 arrows are reduced to zero. In such an embodiment, the reduced colors are represented by a small colored dot without an arrow to enable the user something to grab and drag to access the color components. In a further embodiment, a slider 550 is placed on the right side of the patches to enable a color component to be globally changed for each patch.

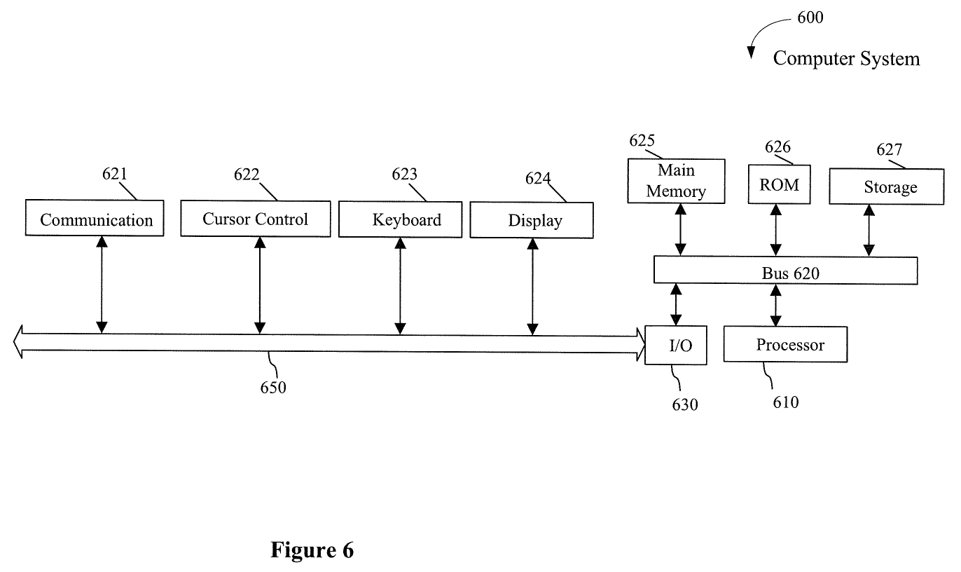

FIG. 6 illustrates a computer system 600 on which data processing system 102 and/or server 108 may be implemented. Computer system 600 includes a system bus 520 for communicating information, and a processor 610 coupled to bus 620 for processing information. Computer system 600 further comprises a random access memory (RAM) or other dynamic storage device 625 (referred to herein as main memory), coupled to bus 620 for storing information and instructions to be executed by processor 610.

Main memory 625 also may be used for storing temporary variables or other intermediate information during execution of instructions by processor 610. Computer system 600 also may include a read only memory (ROM) and or other static storage device 626 coupled to bus 620 for storing static information and instructions used by processor 610. A data storage device 625 such as a magnetic disk or optical disc and its corresponding drive may also be coupled to computer system 600 for storing information and instructions.

Computer system 600 can also be coupled to a second I/O bus 650 via an I/O interface 630. A plurality of I/O devices may be coupled to I/O bus 650, including a display device 624, an input device (e.g., an alphanumeric input device 623 and or a cursor control device 622). The communication device 621 is for accessing other computers (servers or clients). The communication device 621 may comprise a modem, a network interface card, or other well-known interface device, such as those used for coupling to Ethernet, token ring, or other types of networks.

Embodiments of the invention may include various steps as set forth above. The steps may be embodied in machine-executable instructions. The instructions can be used to cause a general-purpose or special-purpose processor to perform certain steps. Alternatively, these steps may be performed by specific hardware components that contain hardwired logic for performing the steps, or by any combination of programmed computer components and custom hardware components.

Elements of the present invention may also be provided as a machine-readable medium for storing the machine-executable instructions. The machine-readable medium may include, but is not limited to, floppy diskettes, optical disks, CD-ROMs, and magneto-optical disks, ROMs, RAMs, EPROMs, EEPROMs, magnetic or optical cards, propagation media or other type of media/machine-readable medium suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Whereas many alterations and modifications of the present invention will no doubt become apparent to a person of ordinary skill in the art after having read the foregoing description, it is to be understood that any particular embodiment shown and described by way of illustration is in no way intended to be considered limiting. Therefore, references to details of various embodiments are not intended to limit the scope of the claims, which in themselves recite only those features regarded as essential to the invention.

What is claimed is:

1. A computer generated method comprising:
receiving a color selection via a graphical user interface (GUI);
generating a mixed color corresponding to the color selection;
drawing a plot around the mixed color within a color palette in the GUI; and
drawing arrows from the plot representing each component of a color space used to generate the mixed color.

2. The method of claim 1 wherein the direction of each arrow indicates a direction for which a particular component changes.

3. The method of claim 2 wherein the length of an arrow indicates how rapidly a corresponding component changes when moved.

4. The method of claim 3 wherein each arrow may be rearranged using the GUI to vary a direction and amount of each component.

5. The method of claim 4 further comprising:
detecting movement of one or more of the arrows; and
changing the colors within the color palette to correspond to the color components indicated by the arrows after one or more of the arrows have been moved.

6. The method of claim 5 further comprising:
determining whether a second color selection has been made corresponding to the color components indicated by the arrows; and
generating a second mixed color corresponding to the color components indicated by the arrows.

7. The method of claim 1 wherein the arrows include four arrows, each corresponding to a color in the cyan, magenta, yellow and black (CMYK) color space.

8. The method of claim 1 wherein the arrows include three arrows, each corresponding to a color in the red green and blue (RGB) color space.

9. A computer system comprising:
a memory to store a computer software product;
a processor, coupled to the memory, to execute the printing software product; and
a display device to display a graphical user interface (GUI) upon the processor executing the computer software product, the GUI having a color palette to enable color selection by providing an independent mix of each color component in a color space.

10. The computer system of claim 9 wherein the color palette comprises:
a plot centered around a mixed color corresponding to a selected color in the palette; and
a plurality of arrows surrounding the plot representing each component of a color space used to generate the mixed color.

11. The computer system of claim 10 wherein the direction of each arrow indicates a direction for which a particular component changes.

12. The computer system of claim 11 wherein the length of an arrow indicates how rapidly a corresponding component changes when moved.

13. The computer system of claim 10 further comprising a cursor control device to rearrange the arrows.

14. The computer system of claim 13 wherein each arrow may be rearranged to vary a direction and amount of each component.

15. The computer system of claim 14 wherein rearranging an arrow changes the colors in the palette to correspond to the color components indicated by the arrows after the rearranging.

16. The computer system of claim 10 further comprising one or more color component selection boxes to enable editing of color component values.

17. The computer system of claim 10 wherein the arrows include four arrows, each corresponding to a color in the cyan, magenta, yellow and black (CMYK) color space.

18. The computer system of claim 10 wherein the arrows include three arrows, each corresponding to a color in the red green and blue (RGB) color space.

19. An article of manufacture comprising a machine-readable medium including data that, when accessed by a machine, cause the machine to perform operations comprising:
receiving a color selection via a graphical user interface (GUI);
generating a mixed color corresponding to the color selection;
drawing a plot around the mixed color within a color palette in the GUI; and
drawing arrows from the plot representing each component of a color space used to generate the mixed color.

20. The article of manufacture of claim 19 wherein the direction of each arrow indicates a direction for which a particular component changes.

21. The article of manufacture of claim 20 wherein the length of an arrow indicates how rapidly a corresponding component changes when moved.

22. The article of manufacture of claim 21 wherein each arrow may be rearranged using the GUI to vary a direction and amount of each component.

23. The article of manufacture of claim 22 when accessed by the machine, further cause the machine to perform operations comprising:
detecting movement of one or more of the arrows; and
changing the colors within the color palette to correspond to the color components indicated by the arrows after one or more of the arrows have been moved.

24. The article of manufacture of claim 23 when accessed by the machine, further cause the machine to perform operations comprising:
determining whether a second color selection has been made corresponding to the color components indicated by the arrows; and
generating a second mixed color corresponding to the color components indicated by the arrows.

25. The method of claim 19 article of manufacture the arrows include four arrows, each corresponding to a color in the cyan, magenta, yellow and black (CMYK) color space.

26. The method of claim 19 article of manufacture the arrows include three arrows, each corresponding to a color in the red green and blue (RGB) color space.

27. A graphical user interface (GUI) comprising a color palette to enable color selection by providing an independent mix of each color component in a color space.

28. The GUI of claim 27 wherein the color palette comprises:
a plot centered around a mixed color corresponding to a selected color in the palette; and
a plurality of arrows surrounding the plot representing each component of a color space used to generate the mixed color.

29. The GUI of claim 28 wherein the direction of each arrow indicates a direction for which a particular component changes.

30. The GUI of claim 29 wherein the length of an arrow indicates how rapidly a corresponding component changes when moved.

31. The GUI of claim 30 wherein each arrow may be rearranged to vary a direction and amount of each component.

32. The GUI of claim 31 wherein rearranging an arrow changes the colors in the palette to correspond to the color components indicated by the arrows after the rearranging.

33. The GUI of claim 27 wherein the arrows include four arrows, each corresponding to a color in the cyan, magenta, yellow and black (CMYK) color space.

34. The GUI of claim 27 wherein the arrows include three arrows, each corresponding to a color in the red green and blue (RGB) color space.
